(19) United States
(12) Patent Application Publication
(10) Pub. No.: US 2012/0024177 A1
(43) Pub. Date: Feb. 2, 2012

(54) Method of Printing Fabric-Inspired Designs On Absorbent Articles

(76) Inventors: Alrick Vincent Warner, Loveland, OH (US); Timothy Wayne Robertson, Cincinnati, OH (US)

(21) Appl. No.: 13/156,583

(22) Filed: Jun. 9, 2011

Related U.S. Application Data
(60) Provisional application No. 61/368,071, filed on Jul. 27, 2010.

(51) Int. Cl. B41F 33/00

(52) U.S. Cl. 101/483

(57) ABSTRACT

Method of printing graphics on absorbent articles. A graphic is selected, the graphic's color(s) are determined, the substrate on which to print the graphic is selected, the size and layout of the graphic are manipulated to make it fit the area of the absorbent article it is to be printed on, and the graphic is printed on a substrate.

### CROSS REFERENCE TO RELATED APPLICATION

This application claims the benefit of U.S. Provisional Application No. 61/368,071, filed Jul. 27, 2010

### FIELD OF THE INVENTION

In one aspect, the invention relates generally to a method of printing graphics on absorbent articles where the graphics comprise designs inspired by designs suitable for or actually embodied in fabric.

### BACKGROUND OF THE INVENTION

Absorbent articles are used commonly. In many cases, e.g. diapers, the purchaser of the absorbent article is not the end user of the article. Many factors influence the purchaser's decision to purchase particular absorbent articles, non-limiting examples of which include: price and product performance, e.g. absorbency, ease of fastening/refastening, tactile feel against the skin, etc. The aesthetics of an absorbent article have become an increasingly important factor in driving purchase decision-making Many purchasers prefer to have colors, patterns, and/or other designs employed by the absorbent article. This creates a need to provide desirable graphics without having an unacceptably negative impact on other decision factors, such as price and absorbency.

It is known to design graphics for absorbent articles. However, what continues to be challenging for manufacturers of absorbent articles is that printing such graphics with excellent on absorbent articles is difficult. This is particularly challenging when the absorbent articles have low basis weight, low modulus, or both. Printing on films and nonwovens that are used in absorbent articles is difficult for a variety of reasons. Some factors affecting printing are the glossiness of the substrate, e.g. matt, semi-gloss, high gloss; its opacity; its original color; and the colors to be printed thereon. Substrates used for absorbent articles may be textured materials, may have a non-even surface, e.g. breathable substrate, each of which increases light scattering, and/or such substrates may be elastic or stretchable which makes it more difficult to print an undistorted graphic. As such, there is a need for improved methods of printing graphics on absorbent articles.

### SUMMARY OF THE INVENTION

In one aspect, the invention relates generally to a method of printing graphics on absorbent articles where the graphics comprise designs inspired by designs suitable for or actually embodied in fabric. In an embodiment of the invention, the method described herein is used to print one or more graphics for an absorbent article. In another embodiment, the graphics match one or more graphics on a particular article of clothing. In yet another embodiment, the graphics match one or more graphics on articles of clothing that comprise a line of clothing.

It is an object of this invention to provide a method of printing graphics on absorbent articles where the graphics comprise designs inspired by designs suitable for or actually embodied in fabric. It is an object of this invention to provide a method of printing with increased detail resolution. It is an object of this invention to provide a method of printing with improved color-to-color register. It is an object of this invention to provide a method of printing with thinner line weight. These and other objects, features, and advantages of the invention will become more apparent upon reading the following specification in conjunction with the accompanying drawing figures.

### BRIEF DESCRIPTION OF DRAWINGS

FIG. 1A is a flowchart of a method of printing graphics on absorbent articles.

FIG. 1B is a flowchart of a method of printing graphics on absorbent articles.

FIG. 2 is a perspective view of a design embodied in an article of clothing.

FIG. 3 is a perspective view of a design embodied in an article of clothing.

FIG. 4 is a perspective view of a design embodied in an article of clothing.

FIG. 5 is a perspective view of a design created using design software, inspired by a creator who has viewed the graphics embodied in an article of clothing.

FIG. 6 is an illustration of three axes (respectively for the L*, a*, and b* value of a given color) used with the CIELAB color scale.

FIG. 7 is a perspective view of a graphic printed on a diaper that was inspired by the design shown in either of FIG. 2 or 5.

FIGS. 8A and 8B are perspective views of graphics printed on diapers that were inspired by the design shown in FIG. 3.

FIGS. 9A and 9B are perspective views of graphics printed on diapers that were inspired by the design shown in FIG. 4.

FIG. 10 is an illustration of the flexographic printing process, in general.

FIG. 11 is an illustration of the Chamber system of ink supply and doctoring system used in the flexography printing process, in general.

FIG. 12 is an illustration of the central impression press used in the flexography printing process, in general.

FIG. 13 is an illustration of the in line press used in the flexography printing process, in general.

FIG. 14 is a bar chart showing certain relationships of the surface energy of print tools and substrates and the surface tension of the inks can lead to unexpected results.

FIG. 15 is a table summarizing L* a* b* data and ΔE data discussed in the Examples.

### DETAILED DESCRIPTION OF THE INVENTION

In one aspect, the invention is intended primarily for use with absorbent articles. As used herein, the term “absorbent article” refers to devices which absorb and contain body exudates, and, more specifically, refers to devices which are placed against or in proximity to the body of the wearer to absorb and contain the various exudates discharged from the body. As used herein, the term “diaper” refers to an absorbent article generally worn by infants and incontinent persons that is worn about the lower torso of the wearer. It should be understood, however, that the invention is also applicable to other absorbent articles such as incontinence briefs, incontinence undergarments, incontinence pads, diaper holders and liners, feminine hygiene garments, feminine hygiene pads, feminine hygiene pantiliners, tampons, and the like. As used herein, the term “disposable” refers to absorbent articles that generally are not intended to be laundered or otherwise restored or reused as absorbent articles, i.e. they are intended to be discarded after a single use, and preferably, to be recycled, composted, or otherwise disposed of in an environmentally compatible manner. In an embodiment, the absorbent articles for which the invention is primarily intended for use, are disposable absorbent articles.

In an embodiment of the invention, the method described herein is used to print one or more graphics for an absorbent article. In another embodiment, the graphics match one or more graphics on a particular article of clothing. In yet another embodiment, the graphics match one or more graphics on articles of clothing that comprise a line of clothing.

Absorbent articles may typically comprise a topsheet having a bodyfacing surface and a garment facing surface, a backsheet having a bodyfacing surface and a garment facing surface, and an absorbent core disposed between the garment facing surface of the topsheet and the bodyfacing surface of the backsheet. In an embodiment, the graphics created by the method disclosed herein are disposed upon the bodyfacing surface of the topsheet. In another embodiment, the graphics are disposed upon the garment facing surface of the topsheet. In another embodiment, the graphics are disposed upon the garment facing surface of the backsheet. In yet another embodiment, the graphics are disposed upon both the bodyfacing surface of the topsheet and the garment facing surface of the backsheet. Other absorbent articles, e.g. catamenial tampons, may typically comprise a compressed absorbent core disposed within an overwrap substantially covering the exterior surface of the compressed absorbent core, the overwrap having a core facing surface and a bodyfacing surface. In an embodiment, the graphics created by the method disclosed herein are disposed upon the core facing surface of the overwrap. In another embodiment, the graphics are disposed upon the bodyfacing surface of the overwrap. In yet another embodiment, the graphics are disposed upon both the core facing surface of the overwrap and the bodyfacing surface of the overwrap. In an embodiment, the overwrap comprises a non-woven material.

Printing may generally be characterized as an industrial process in which an image is reproduced on a substrate, such as paper, polyolefin film, or nonwoven fabric. There are various classes of printing processes, which may include stencil and screen printing, relief printing, planographic printing, intaglio printing, and electronic printing. Stencil and screen printing may be used for printing T-shirts, signage, banners, billboards, and the like. Examples of relief printing may include letterpress and flexography. Examples of planographic printing may include offset lithography, screenless lithography, collotype, and waterless printing. In addition, examples of intaglio printing may include gravure, steel-die, and copper-plate engraving. Examples of electronic printing may include electrostatic, magnetographic, ion or electron deposition, and ink-jet printing. It is it to be appreciated that various types of printing processes may be used to create the graphics disclosed herein. For example, in some embodiments, it may be preferable to use flexography. In particular, flexography may utilize printing plates made of rubber or plastic with a slightly raised image thereon. The inked plates are rotated on a cylinder which transfers the image to the substrate. Flexography may be a relatively high-speed print process that uses fast-drying inks. In addition, flexography can be used to print continuous patterns on many types of absorbent and non-absorbent materials. Other embodiments may utilize gravure printing. More particularly, gravure printing utilizes an image etched on the surface of a metal plate. The etched area is filled with ink and the plate is rotated on a cylinder that transfers the image to the substrate. Still other embodiments may utilize ink jetprinting. Ink jet is a non-impact dot-matrix printing technology in which droplets of ink are jetted from a small aperture directly to a specified position on a media to create an image. Two examples of inkjet technologies include thermal bubble or bubble jet and piezoelectric. Thermal bubble uses heat to apply to the ink, while piezoelectric uses a crystal and an electric charge to apply the ink.

In addition to the aforementioned various types of printing processes, it is to be appreciated that various types of inks or ink systems may be applied to various types of substrates to create the disclosed patterns, such as solvent-based, water-based, and UV-cured inks. The primary difference among the ink systems is the method used for drying or curing the ink. For example, solvent-based and water-based inks are dried by evaporation, while UV-cured inks are cured by chemical reactions. Inks may also include components, such as solvents, colorants, resins, additives, and (for ultraviolet inks only) UV-curing compounds, that are responsible for various functions.

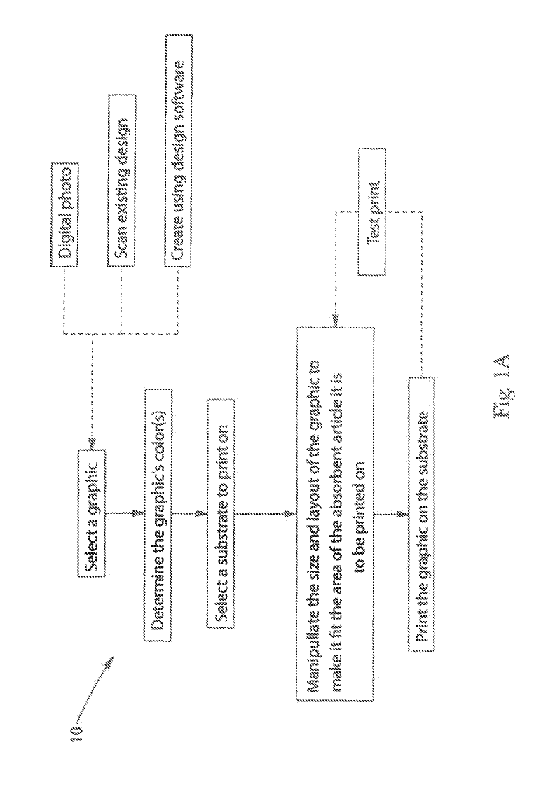

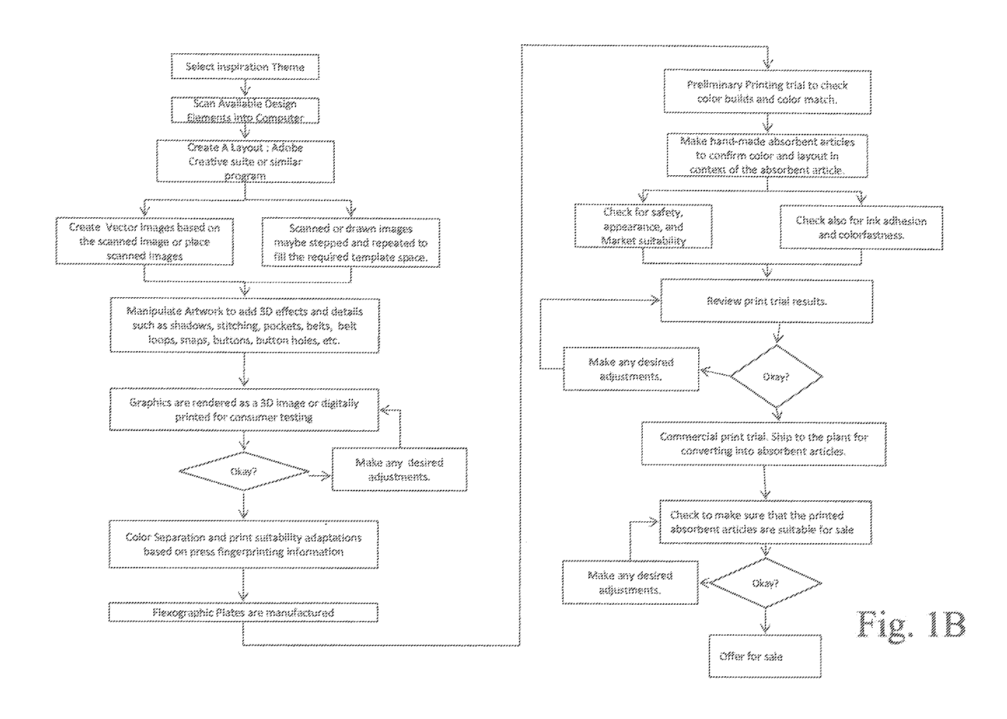

As shown in FIG. 1A, a method of printing graphics on absorbent articles 10 is provided. According to method 10, which comprises one or more of the following steps, in step 20, a graphic is selected, in step 30, the graphic's color(s) are determined, in step 40, the substrate on which to print the graphic is selected, in step 50, the size and layout of the graphic are manipulated to make it fit the area of the absorbent article it is to be printed on, and in step 60, the graphic is printed on a substrate. These steps and additional optional steps are discussed in more detail herein. It is to be noted that, as depicted in FIG. 1A, an embodiment provides that step 30 occurs prior to step 40. However, it will be appreciated by the skilled person that in another embodiment, step 40 occurs prior to step 30, and in yet another embodiment, steps 30 and 40 are performed concurrently.

As shown in FIG. 1B, a method of printing graphics on absorbent articles 200 is provided. According to method 200, which comprises one or more of the following steps, in step 210, an inspirational theme is selected, in step 220, available design elements are scanned into a computer file, in step 230, a layout is created (using Adobe Creative Suite® or similar software), in step 240, vector images are created based on the scanned image or scanned images are placed on a template of the absorbent article to be printed on, in step 250, scanned or drawn images may be stepped and repeated to fill the space on a template of the absorbent article to be printed on, in step 260, artwork is manipulated to add 3-dimensional effects and details, e.g. shadows, stitching, pockets, belts, belt loops, snaps, button, button holes, and the like, in step 270, graphics are rendered as a 3-dimensional image or digitally printed for consumer testing, in step 280, a determination is made of consumers' acceptance of the graphics, in step 290, an editing loop is provided whereby any desired changes to improve consumer acceptance are made, in step 300, color separation and print suitability adaptations are determined and made based on press fingerprinting information, in step 310, flexographic plates are manufactured, in step 320, a preliminary printing trial is conducted to check color builds and color match, in step 330, hand-made absorbent articles are made to confirm color and layout in the context of the absorbent article, in step 340, a check is conducted to check the safety, appearance, and market suitability of the absorbent articles, in step 350, a check is conducted to check ink adhesion and colorfastness, in step 360, print trial results are reviewed, in step 370, a determination is made of whether the print trials were successful for the attributes measured, in step 370, an editing loop is provided whereby any desired changes to improve success for the attributes measured are made, in step 380, a commercial print trial is conducted wherein absorbent articles are shipped to a manufacturing plant for being converted into saleable absorbent articles, in step 390, a check is conducted to check whether the printed absorbent articles are suitable for sale, in step 400, a determination is made of whether the printed absorbent articles are suitable for sale based on the attributes measured, in step 410, an editing loop is provided whereby any desired changes to improve success for the attributes measured are made, in step 420, the printed absorbent articles suitable for sale are offered for sale. These steps and additional optional steps are discussed in more detail herein. It is to be noted that, as depicted in FIG. 1B, an embodiment provides that step 240 and 250 occur concurrently. However, it will be appreciated by the skilled person that in another embodiment, step 240 occurs prior to step 250, and in yet another embodiment, step 250 occurs prior to step 240. It is to be noted that, as depicted in FIG. 1B, an embodiment provides that step 340 and 350 occur concurrently. However, it will be appreciated by the skilled person that in another embodiment, step 340 occurs prior to step 350, and in yet another embodiment, step 350 occurs prior to step 340.

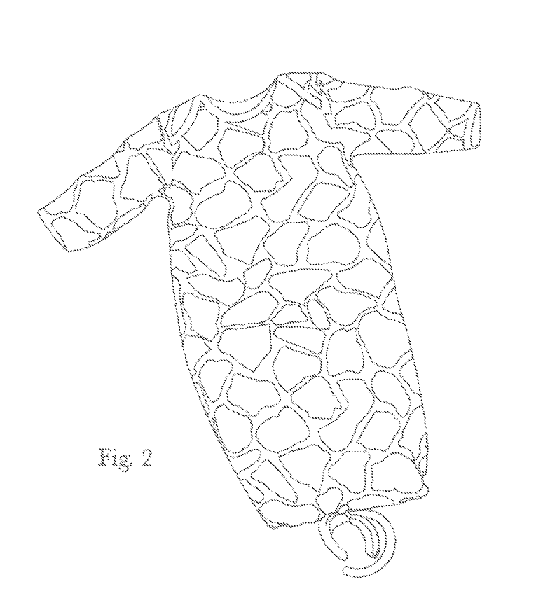

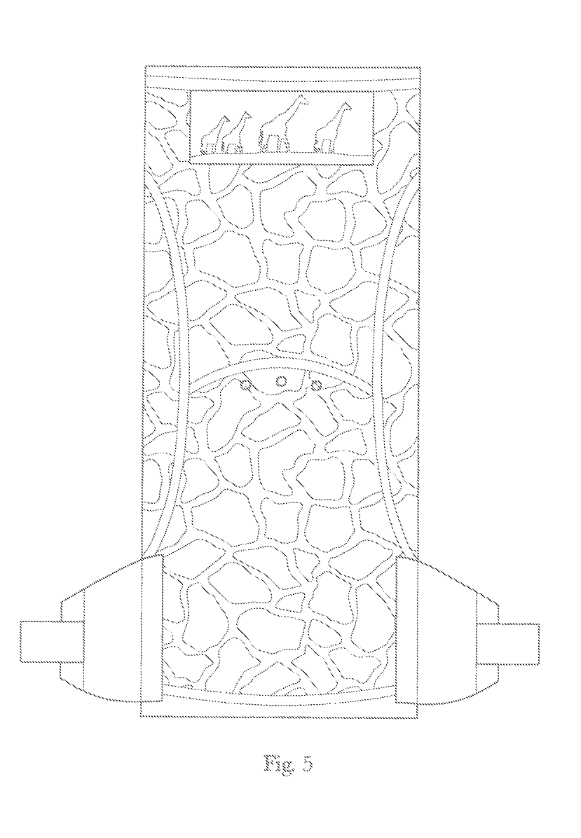

In step 20, a graphic is selected. The graphic comprises one or more designs inspired by designs suitable for or actually embodied in fabric. The graphic may be embodied in an electronic file. Suitable file formats are JPG, JPEG, PNG, GIF, TIF (e.g. 8-bit, uncompressed). Preferably, the file will be less than 30 megabytes in size. The source of the graphic may vary. In certain embodiments of the invention, the design may be embodied in a fabric, an article of clothing, a clothing line, artwork, a painting, or the like. In any of the aforementioned embodiments, the graphic may be reduced in the form of a digital photograph, or in the form of an electronic scan. Examples of the design being embodied in an article of clothing are shown in FIGS. 2, 3, and 4. In yet another embodiment, the graphic is created using design software, e.g. Adobe Photoshop® or Adobe Illustrator®. In such an embodiment, the design may be created from scratch, or it may be inspired by a creator who has viewed the graphics embodied in a fabric, an article of clothing, a clothing line, artwork, a painting, or the like. An example of the design being created using design software, inspired by a creator who has viewed the graphics embodied in an article of clothing, is shown in FIG. 5.

The use of a higher quality file at this point in the process will typically result in a higher quality print ultimately being printed. In one embodiment, resolution of the image of the graphic embodied in the file will be at least 150 dpi (dots per inch). When flexographic printing is used, preferably the print size of an image to be printed, in pixel dimensions, will be 150 times the number of inches. Thus, for example, to ultimately print on an 8″×8″ swatch, the image embodying the graphic will have a resolution of 1200 pixels×1200 pixels.

In an embodiment where the graphic is a scan of a design, suitable scanners will typically scan at 2400 dpi resolution or higher. Suitable scanners include the Epson® Expression® 10000XL, which is particularly useful when the graphic is embodied in a fabric.

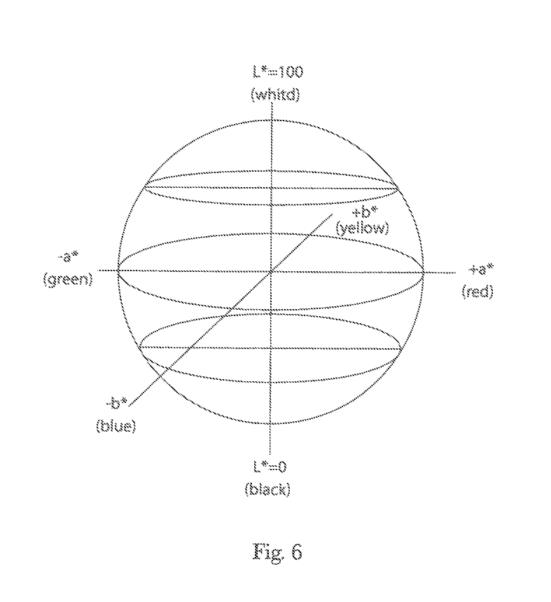

In step 30, the color(s) of the graphic are determined CIELAB is a conventional color model used to describe colors visible to the human eye. FIG. 6 is an illustration of three axes (respectively for the L*, a*, and b* value of a given color) used with the CIELAB color scale. When a color is defined according to the CIELAB color scale, L* represents lightness (0=black, 100=white), a* and b* independently each represent a two color axis, a* representing a red/green axis (+a=red, −a=green), while b* represents a yellow/blue axis (+b=yellow, −b=blue). The maximum for L* is 100, which represents a perfect reflecting diffuser, and the minimum for L* is zero, which represents black. The a* and b* axes have no specific numerical limits. The CIELAB color scale is an approximate uniform color scale, wherein the differences between points plotted in the color space correspond to visual differences between the colors plotted. Based on the L*, a*, and b* values for a first color (i.e. L₁, a₁, b₁) and a second color (i.e. L₂, a₂, b₂), the difference between the colors (i.e. ΔE) can be calculated using the following formula:

ΔE=√(ΔL*²+Δa*²+Δb*²)

wherein,
ΔL*=L₁−L₂;
Δa*=a₁−a₂; and
Δb* =b₁−b₂

The L*a*b* values for each zone of color in the graphic may be determined in various ways. For example, the L*a*b* values of the color zones may be determined by using ink with relatively known L*a*b* values. Alternatively, the L*a*b* values in a zone can be determined from the electronic file that is generated when a pattern is created. In such a case, the L*a*b* values may be obtained with a computer equipped with a software that can provide the L*a*b* value of a selected area. A non-limiting example of such software may be Adobe Photoshop®. In another embodiment, the L*a*b* values of various color zones on a graphic can be measured directly from the printed substrate that bears the design inspiring the graphic. A suitable procedure for measuring the L*a*b* values of a color zone is provided below.

In an embodiment, color measurements are performed using a commercial flat bed scanner capable of 4800 dpi, at 16 bit color depth, such as an Epson Perfection V500 Photo scanner (Epson America, Long Beach, Calif.). Each scan is calibrated against Pantone standards, and measurements made using Adobe Photoshop CS3 Extended Edition (Adobe Systems, Inc, San Jose, Calif.). The sample is measured on the printed side of the substrate. For example, if a laminate consist of a nonwoven and a film where the printing is on the film and sandwiched between the film and nonwoven, the nonwoven is removed before the printing on the film is measured.

Scans are calibrated using the Pantone Process Colors standard from the Pantone Formula Guide - Uncoated Papers (Pantone, Carlstadt, N.J.). CIE L*a*b* values are measured for the

Pantone standard for each color, i.e., Process Yellow U, Process Magenta U, Process Cyan U, Process Black U, and the White uncoated paper. Tristimulus colors are measured according to ASTM Method E1164-07 (Standard Practice for Obtaining Spectrophotometric Data for Object-Color Evaluation) using a Hunter Labscan XE (HunterLab, Reston, Va.) with HunterLab Universal Software vs. 4.10 with the following settings: Scale CIELAB, 0/45 StdMode, Area View 0.50 in., Port Size 0.70 in., UV filter Nominal. During measurement the standard is backed using the white calibration plate provided by HunterLab. To increase the reliability of the measurement, each color should be measured at least in triplicate and averaged. The sample is placed on the scanner with the printed-side toward the sensor. The Pantone standard is also placed on the scanner such that the sample and standard are both captured in the same image.

The scan is collected at 1200 dpi at 8 bit color depth into Photoshop for objects with a primary dimension of greater than 3 mm, and at 2400 dpi, 8 bit color depth for objects with a primary dimension of less than 3 mm. Within Photoshop, the image is transformed into a Lab, 8 bit image (note in this version of Photoshop, L*a*b* is imprecisely denoted as Lab). Using the “Levels” command, the L channel of the image is adjusted to read within 2 units for each of the yellow, magenta, cyan, black and white colors on the Pantone standard. L*a*b* values are measured using the Color Sampler Tool using an 11 by 11 average sample size.

In step 40, the substrate on which to print the graphic is selected. The graphic may be selected to be printed on a suitable area for printing on any surface suitable for printing on the absorbent article. In an embodiment, the graphic is to be printed on the backsheet of an absorbent article. In another embodiment, it is to be printed on the ear of a diaper. In an embodiment, the substrate has a basis weight of less than or equal to 20 gsm.

In an embodiment, the substrate has a low modulus, i.e. ≦20 Newtons/cm. In another embodiment, the modulus of the substrate is from 16 to 20 N/cm. In another embodiment, the modulus is ≦16 N/cm. Applicants have learned that high winding speeds of 1000 feet per minute or more, along with various film properties, can impart defects into the wound layers of film during winding. For example, non-uniform tensions and/or pressures are oftentimes imparted to the film during winding (e.g., at the outermost wound layers and near the core of the roll) due to various factors such as tension variations in the winding device (e.g., tolerance run-outs in the winding cylinder), film stability at the winding device, caliper control of the film, etc. The resulting unevenness between the two wound layers (e.g., the outermost wound layer and an immediately underlying wound layer) can produce a wound-in defect(s) that later “grows” as multiple successive windings layers of the film are wound on top of the defect(s). These winding-induced defects can include: variations in print repeat length, tin can-type defects (e.g., the film roll exhibits a series of raised annular bands so as to resemble the side of a tin can), and gauge band types of defects. In this regard, while efforts are made to precisely design and build the mechanical components of the winding device, for large film width winding applications (e.g., on the order of 1 meter, 1.5 meters or even 2 meters or greater), unavoidable precision runouts tend to produce non-uniform tension during winding; in instances where the affected film layer is unable to readily move (or relax) relative to the immediately underlying layer (e.g., due to friction), one or more of the winding-induced defects mentioned above can occur. Winding defects are typically more frequently observed when the film is thin, has a low basis weight, and/or has a low modulus. In an embodiment, the film is has a thickness of ≦1 mm; preferably it is ≦0.75 mm. In an embodiment, the film has a basis weight of ≦20 gsm; preferably ≦16 gsm. In an embodiment, the film has a modulus of ≦20 N/cm; preferably about 16 N/cm. In an embodiment, the film is has a thickness of ≦1 mm, a basis weight of ≦20 gsm, and a modulus of ≦20 N/cm. In yet another embodiment, the film is has a thickness of ≦0.75 mm, a basis weight of ≦16 gsm, and a modulus of 16 N/cm.

In step 50, the size and layout of the graphic are manipulated to make it fit the area of the absorbent article it is to be printed on. The graphic can be centered on a template of the area to be printed, e.g. the diaper backsheet, by any suitable process that obtains the desired color and shape of the graphic for the given print area. In an embodiment, a designer alters the size or dimensions of the graphic to fit the area of the absorbent article substrate to be printed on. This typically involves cropping, enlarging/decreasing the overall dimensions of the graphic, and may involve modifying the graphic itself by introducing or removing design features of the graphic in order to make it fit the print area. Care should be taken not to modify the graphic in a way that causes too much detail to be lost.

The difference between the colors (i.e. ΔE) can be used to compare the colors graphic being printed versus target, e.g. when conducting test prints. In one embodiment, the ΔE between the graphic being printed and the original design is less than 16. In another embodiment, the ΔE between the graphic being printed and the original design is less than 12. In yet another embodiment, the ΔE between the graphic being printed and the original design is less than 9.

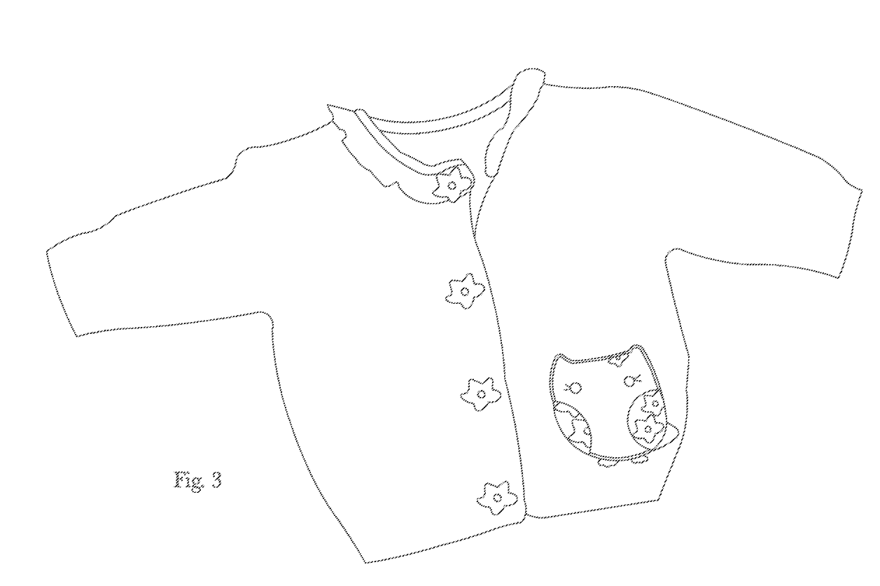

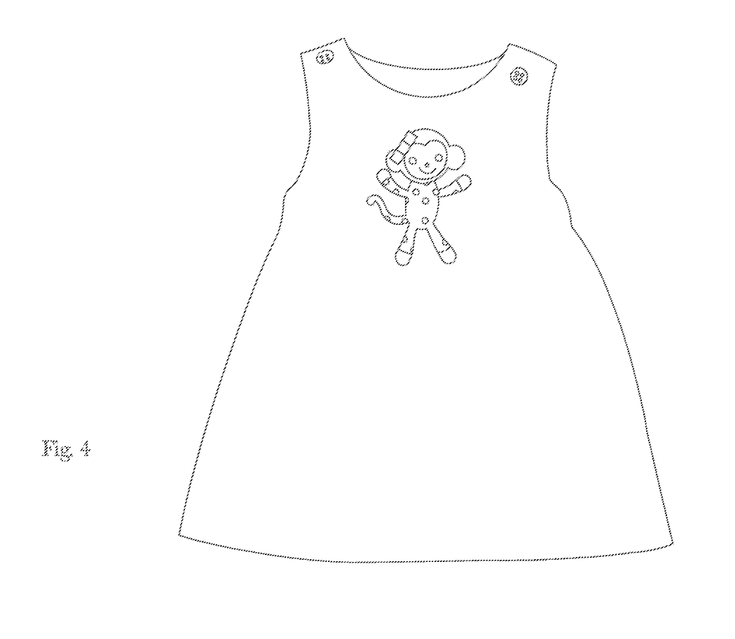

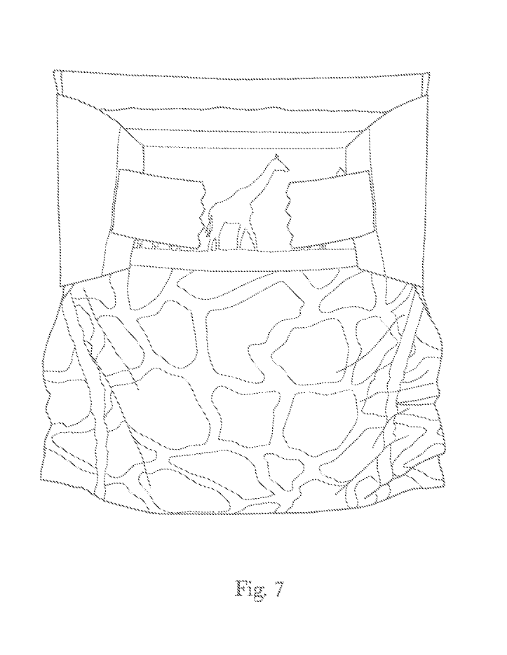

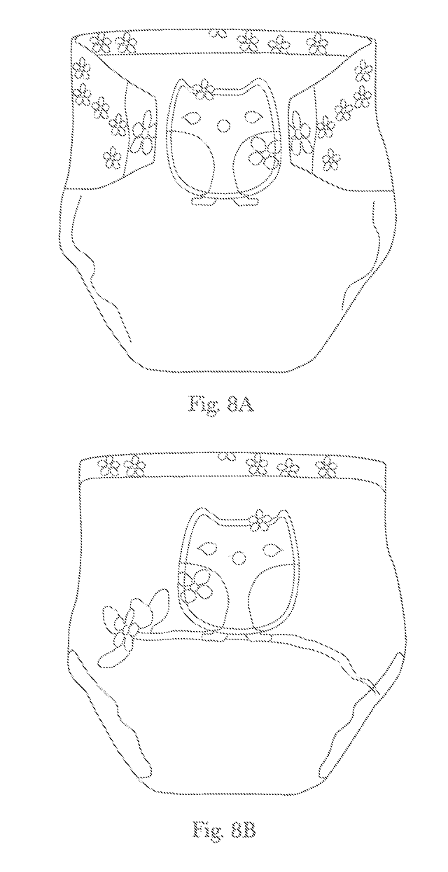

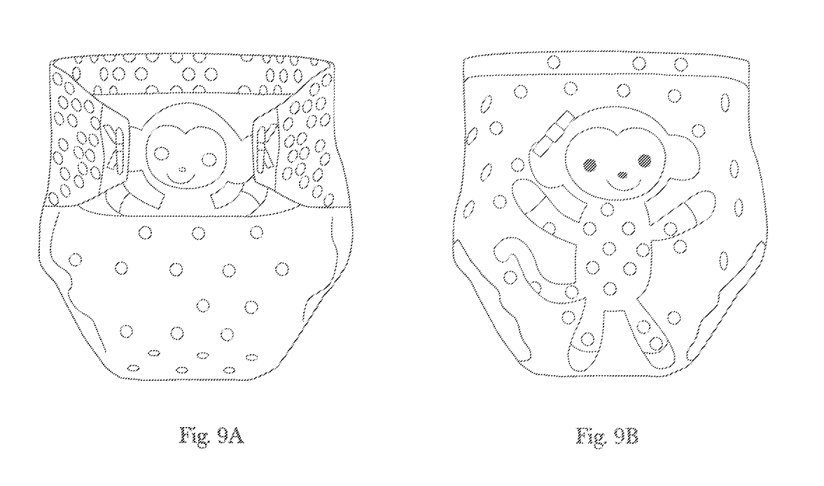

In step 60, the graphic is printed on a substrate. FIG. 7 shows a graphic printed on a diaper that was inspired by the design shown in either of FIG. 2 or 5. FIGS. 8A and 8B show a graphics printed on diapers that were inspired by the design shown in FIG. 3. FIGS. 9A and 9B show graphics printed on diapers that were inspired by the design shown in FIG. 4.

Optionally, one or more test prints are done. Settings may be adjusted, e.g. color, size, and/or shape, after each successive test print until the desired color and appearance of the graphic are obtained. One factor to consider in adjusting settings is to compare the colors and density of the graphic being printed versus target. Colors may be printed by using a variety of methods. Some suitable methods are single spot color; 4-color process printing (using cyan, magenta, yellow, and black; also known as “CMYK”); expanded color gamut 6-color or 7-color (CMYK+orange, green, and violet; also known as “OGV”); or a combination of 4-color, 6 color, or 7 color process printing with spot color printing. In an embodiment, 7 color process printing is combined with spot color printing. Additional factors to consider in adjusting settings are the shape and layout of the graphic. This may also include color-to-color alignment. Yet another factor to consider in adjusting settings is ink adhesion, e.g. how well it resists rub-off and/or leaching.

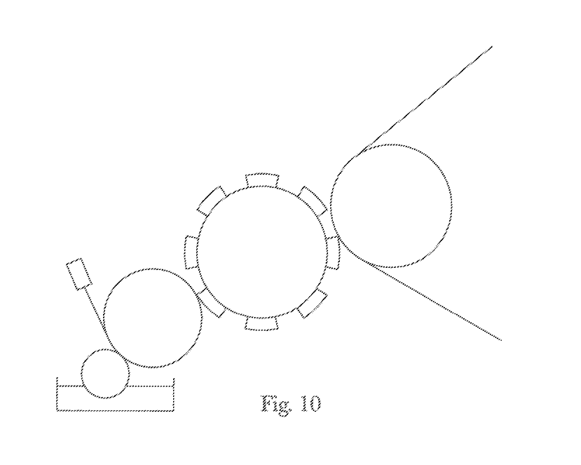

In an embodiment, the graphic is printed using a flexographic press. As shown in FIG. 10, the flexographic generally operates by transferring ink from a soft rubber transfer roller to an anilox roll; this roll is filled with billions of tiny cells. Once they are filled, a doctor blade is used to scrape away any excess ink from the surface of the roller; this meters the quantity of ink to reach the printing plate. Ink is spread evenly on the anilox rollers to transfer ink to the raised parts of the flexible printing plate. The printing plate is wrapped around a plate cylinder. The raised sections of a flexographic printing plate are coated with ink ready to be pressed on the material to be printed. An impression cylinder presses the substrate (film) to be printed against the printing plate. The raised sections of the printing plate transfer their ink coating to the material being printed. The ink is dried. Each ink color requires its own anilox inking rollers, plate and cylinder, and colors are printed one after the other on to the material as it passes through the press.

In an embodiment, the flexographic press has a color-to-color registration accuracy of ±0.04 mm. Such a press is the ASTRAFLEX®, available from Windmoeller & Hoelscher Corp. Accordingly, by using a flexographic press with such accuracy in color-to-color registration, graphics may be printed having very narrow lines as fine as ≦0.032 inch in width, preferably 0.020 inch. Also suitable are flexographic presses known as the NOVOFLEX® and VISTAFLEX® (both available from W&H).

Suitable printing plates are typically made from one or more photopolymers and are typically supplied in flat sheets of un-reacted polymer. They are then processed by specialist pre-press houses. The use of a higher quality plate at this point in the process will typically result in a higher quality print ultimately being printed. Raised areas of the plate transfer the ink. In an embodiment, the relief is up to and including 0.8 mm in height. In an embodiment, the total thickness of the plate is from 1.3 to 1.7 mm, preferably 1.5 mm. In various embodiments, the thickness of the plate is selected from 1.14 mm (0.045″), 1.70 mm (0.067″), 2.28 mm (0.090″), 2.54 mm (0.100″), 2.72 mm (0.107″), and 2.84 mm (0.112″). In an embodiment, the thickness of the plate is 1.70 mm (0.067″) with a relief of 0.020 inch. In another embodiment, the thickness of the plate is 1.70 mm (0.067″) with a relief of 0.025 inch.

The anilox and doctor blade meter an even amount of ink to the printing plate. The ink is held in the billions of anilox cells while the doctor blade runs over the surface of the anilox removing any excess ink. The anilox is typically manufactured from a ceramic compound whose hardness provides long life and is resistant to abrasion from the doctor blade. The anilox roll is manufactured to release a certain ink weight from the laser engraved cells, so the size of the cells and resolution are important to the color on the final printed image.

There are two main types of ink supply and doctoring system used in flexography. In open systems the anilox rotates in an open bath of ink and the doctor blade meters the ink just prior to the ink being transferred to the plate cylinder.

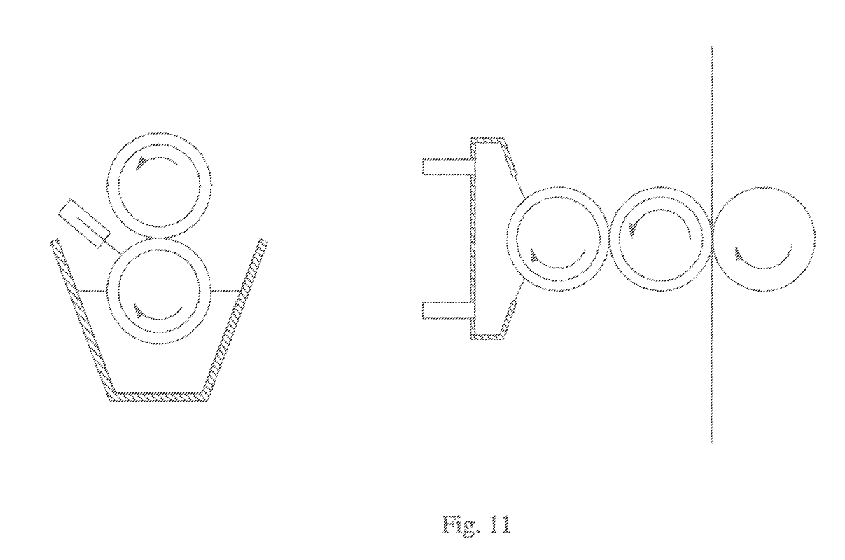

As shown in FIG. 11, the Chamber system encloses the ink using two blades within a chamber. The retaining blade at the bottom acts as a seal while the doctor blade at the top performs the ink metering. The ink is pumped through the system to maintaining a constant supply of ink to the anilox surface. Advantageously, the closed doctoring system requires less ink to “charge” the system and there is no release of VOC's, as the system is contained.

In an embodiment, the flexographic printing press comprises from 2 to 10 stations. These include but are not limited to three main configurations, the central impression press, the in-line press, and the stack press.

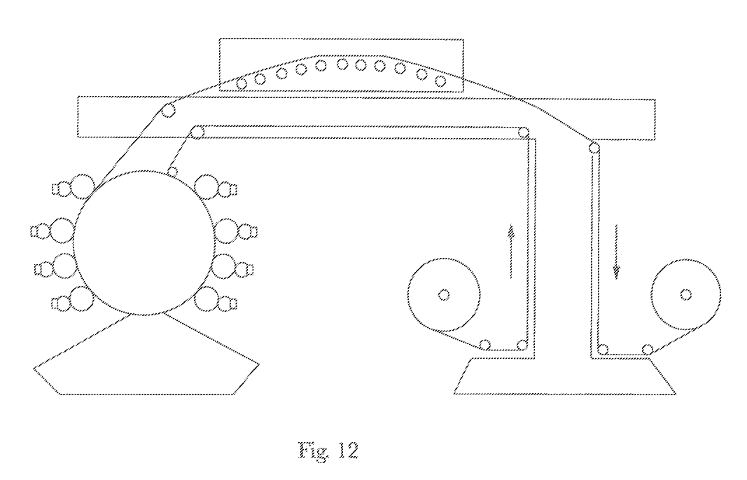

As shown in FIG. 12, a web passes around the central impression (CI) cylinder with each color being printed in turn. Inter-station driers are used to cure the inks between print stations to ensure wet on dry printing. An advantage of this type of press is that registration is excellent, as the web is held over the CI drum between print stations. There is less chance of the substrate being extended between the print stations. The press speed of central impression presses can generally be increased beyond that of the other press types.

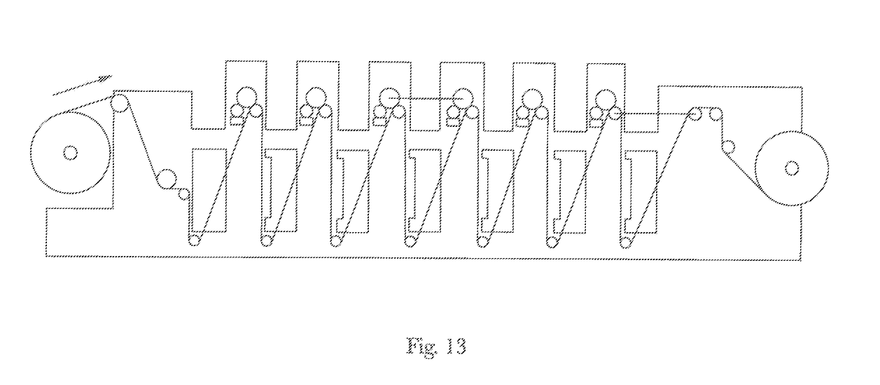

As shown in FIG. 13, the in line press is a combination of individual units with a small distance between the print heads. Each color is printed on the web fed substrate. Each color has an individual impression cylinder against which the plate is pressed. An advantage of the in line press is that other printing technologies (such as rotary screen or gravure) and additional colors/processes can be incorporated by simply adding another station. These machines often use UV inks which are dried between each print station.

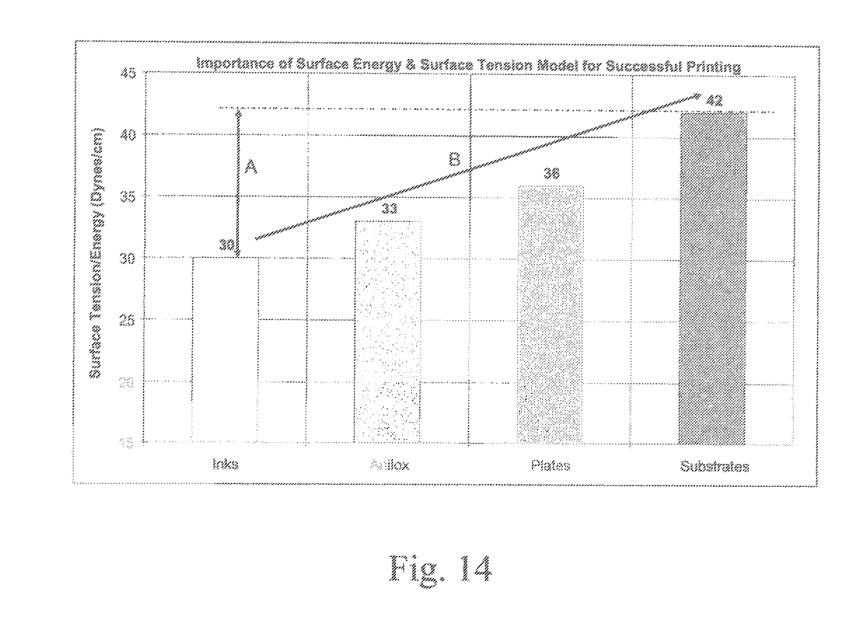

Applicants have also surprisingly found that when using flexographic printing, certain management of the surface energy of print tools and substrates and the surface tension of the inks can lead to unexpected results. As shown in FIG. 14, and in one embodiment, the surface tension/energy of the components of the printing process are advantageously arranged such that it increases from the inks, to anilox, to plates, to substrates. In one embodiment, the difference in surface tension /energy between the inks and the substrates is from 10 to 14 dynes, preferably 12 dynes/cm.

A design will typically comprise various design elements of the absorbent article. Design elements may be physical features of the absorbent article, such as the overall outline, location of tabs, fasteners, borders, junctions of materials, stitching, and like elements. Design elements may also be either actual physical features of the absorbent article or elements that are not actual physical features but are to be printed on the absorbent article to make it appear that they are actual elements of the absorbent article, non-limiting examples of features that may fall within either or both of these groups include: printing borders, seams, pockets, zippers, zipper flaps, topstitching, embossment, quilting, buttons, bows, ribbons, straps, snaps, belt loops, suspenders, sales tags, etc.

A design may also be themed or exhibit an otherwise like group of colors and patterns and/or solid prints. In an embodiment, they may be selected from groups being categorized as being gender neutral, boy appropriate, or girl appropriate. In another embodiment, they may be selected from groups categorized as being sporty, outdoors, sophisticated, professional, casual, cute, sassy, feminine (e.g. quilted, paisley, curly cues, polka dots), fresh, seasonal (e.g. spring, summer, fall, winter), patriotic, weather/climatic (e g sunny, rainy, snowy), ethnic, soft tones, earth tones, pastels, rock 'n roll, western (e.g. cowboy/cowgirl), animal, plant, food, or industrial.

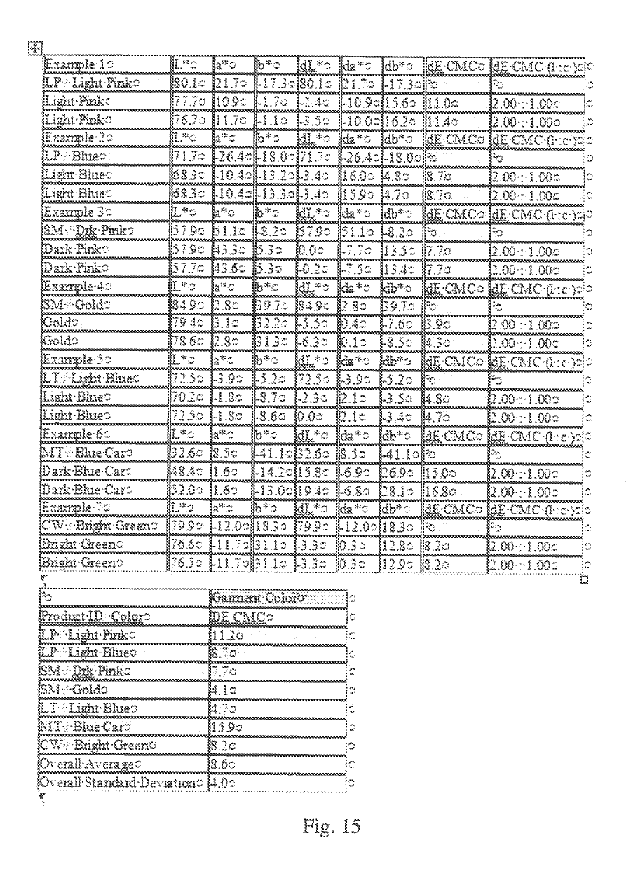

As previously mentioned, the difference between the colors (i.e. ΔE) can be used to compare the colors graphic being printed versus target, e.g. when conducting test prints. The following examples provide L* a* b* data measured from different colors (each respective example, not within any given example) for the original design (measured once) and the printed substrate (two measurements taken). The data is presented in summary fashion in FIG. 15.

### EXAMPLES

Test Sample 1 includes a color light pink printed on a nonwoven substrate. The nonwoven substrate of Test Sample 1 is a 17 gsm carded polypropylene.

Test Sample 2 includes a color light blue printed on a nonwoven substrate. The nonwoven substrate of Test Sample 1 is a 17 gsm carded polypropylene.

Test Sample 3 includes a color dark pink printed on a nonwoven substrate. The nonwoven substrate of Test Sample 1 is a 17 gsm carded polypropylene.

Test Sample 4 includes a color gold printed on a nonwoven substrate. The nonwoven substrate of Test Sample 1 is a 17 gsm carded polypropylene.

Test Sample 5 includes a color light blue printed on a nonwoven substrate. The nonwoven substrate of Test Sample 1 is a 17 gsm carded polypropylene.

Test Sample 6 includes a color dark blue printed on a nonwoven substrate. The nonwoven substrate of Test Sample 1 is a 17 gsm carded polypropylene.

Test Sample 7 includes a color bright green printed on a nonwoven substrate. The nonwoven substrate of Test Sample 1 is a 17 gsm carded polypropylene.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of printing graphics on absorbent articles comprising the steps of:
a. selecting a graphic;
b. determining the graphic's color or colors;
c. selecting a substrate on which to print the graphic;
d. manipulating the size and layout of the graphic to make it fit the area of the absorbent article it is to be printed on; and
e. printing the graphic on a substrate.

2. The method of claim 1, wherein the absorbent articles are diapers.

3. The method of claim 1, wherein the absorbent articles are feminine pads, pantiliners, or tampons.

4. The method of claim 1, wherein the absorbent articles are incontinence pads.
